(19) United States
(12) Patent Application Publication
(10) Pub. No.: US 2017/0327309 A1
(43) Pub. Date: Nov. 16, 2017

(54) SILO WITH RECONFIGURABLE ORIENTATION

(71) Applicant: Halliburton Energy Services, Inc., Houston, TX (US)

(72) Inventors: Timothy Holiman Hunter, Duncan, OK (US); Leonard Ray Case, Duncan, OK (US); Calvin Lynn Stegemoeller, Duncan, OK (US)

(73) Assignee: Halliburton Energy Services, Inc., Houston, TX (US)

(21) Appl. No.: 15/526,965

(22) PCT Filed: Dec. 23, 2014
(86) PCT No.: PCT/US2014/072114

§ 371 Date: May 15, 2017

(51) Int. Cl. B65D 88/30; B65D 88/54; B65D 88/12; B65D 88/08; B65B 69/00; B65D 90/12; B60P 1/64

(52) U.S. Cl. CPC B65D 88/30; B65D 90/125; B65D 88/54; B60P 1/64; B65D 88/08; B65B 69/0091; B65D 88/12

(57) ABSTRACT

In accordance with embodiments of the present disclosure, systems and methods for reconfiguring a vertical storage silo used to store proppant (or other dry material) so that the storage silo may be used in a desired orientation at a worksite are provided. The disclosed embodiments may include a vertical storage silo assembly used to selectively deliver material from one of two different outlet orientations. The silo assembly may offer two distinct orientations for an outlet chute relative to a transportation chassis used to transport and erect the vertical silo. The silo assembly may include a storage silo and a base for supporting the storage silo in a vertical orientation, the storage silo being removably coupled to the base. The storage silo may also be rotatable relative to the base to transition or reposition the outlet chute between a right-hand orientation and a left-hand orientation relative to the base.

### TECHNICAL FIELD

The present disclosure relates generally to transportable silos used for handling bulk materials, and more particularly, to vertical silos having reconfigurable orientations for outputting bulk material.

### BACKGROUND

During the drilling and completion of oil and gas wells, various wellbore treating fluids are used for a number of purposes. For example, high viscosity gels are used to create fractures in oil and gas bearing formations to increase production, to maintain positive hydrostatic pressure in the well during installation of completion equipment, and to flow sand into wells during gravel packing operations. The high viscosity fluids are normally produced by mixing dry powder and/or granular materials and agents with water at the well site as they are needed for the particular treatment. Systems for metering and mixing the various materials are normally portable, e.g., skid- or truck-mounted, since they are needed for only short periods of time at a well site.

Supply tanks of various sizes and shapes can be used for metering proppant, dry powder, and other materials into a blender as needed. Such supply tanks sometimes include vertical proppant storage silos, which are positioned in a vertical orientation and rely on gravity to convey or meter the dry materials. Vertical storage silos are rapidly gaining acceptance in the field of oil and gas, in part due to the small footprint they exhibit at a well location. The vertical silos utilize approximately one third of the surface space that might otherwise be used by a horizontal storage unit of the same capacity.

Vertical silos are often delivered to a desired location on a chassis with transporting and erection equipment used to erect the silo from a horizontal transportation orientation on the chassis to a vertical orientation. Unfortunately, when setting up the vertical silos in this manner, it can be difficult to orient the outlet ducting (for dry material) of the silo relative to a receiver device used to transfer the dry material to the blender. Such outlet ducting is typically fixed at one end to an outlet position on the silo. When space is limited at the worksite, it can be difficult to maneuver the horizontal silo mounted in a certain orientation on the transporting/erecting chassis into a desired vertical position.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a perspective view of an arrangement of vertically oriented storage silos at a worksite, in accordance with an embodiment of the present disclosure;

FIG. 2 is a perspective view of a reconfigurable storage silo disposed horizontally and in a left-hand orientation on a transportation chassis, in accordance with an embodiment of the present disclosure;

FIG. 3 is an above view of a reconfigurable storage silo disposed vertically and in a right-hand orientation on the ground near a transportation chassis, in accordance with an embodiment of the present disclosure;

FIG. 4 is a perspective view of a reconfigurable storage silo being rotated with respect to a base component and a transportation chassis, in accordance with an embodiment of the present disclosure;

FIG. 5 is a perspective view of a flange connection between a reconfigurable storage silo and a base component, in accordance with an embodiment of the present disclosure; and

FIG. 6 is a perspective view of a reconfigurable storage silo disposed vertically on a ground surface, in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

Certain embodiments according to the present disclosure may be directed to systems and methods for reconfiguring a vertical storage silo used to store proppant (or other dry material) so that the storage silo may be used in a desired orientation at a worksite. Specifically, the disclosed embodiments may include a vertical storage silo assembly used to selectively deliver material from one of two different outlet orientations. The silo assembly may offer two distinct orientations for an outlet chute relative to a transportation chassis used to transport and erect the vertical silo assembly. Although described herein as providing two orientations for the outlet chute, the disclosed techniques may be applied to provide any desirable number of outlet chute orientations.

In some embodiments, the system may include a storage silo and a base for supporting the storage silo in a vertical orientation, the storage silo being removably coupled to the base. An outlet chute for directing dry material out of the silo and into another container (e.g., blender hopper) may be coupled at one end to a fixed outlet position on the silo. The silo may be rotatable relative to the base to transition or reposition the outlet chute between a right-hand orientation and a left-hand orientation relative to the base. This may enable the silo to be transported to a worksite in a right or left-hand orientation, erected at the worksite, and transitioned to a desired orientation at the worksite, or at a local service area.

In other embodiments, the system may include a storage silo coupled to the base with an outlet chute having one end that is fixed to a certain location on the storage silo. The base may include two sets of lower attachments for coupling a lifting arm of a transportation chassis to the base in one of two different orientations. These two orientations of the silo relative to the transportation chassis may correspond to a right-hand and left-hand orientation of the outlet chute relative to the transportation chassis.

The systems and methods described herein may eliminate the need to manufacture separate silos configured for use in right-hand orientations or left-hand orientations at a worksite. Instead, the units described below may be easily converted between the left and right-hand orientations either on site or at a local service area. In addition, the disclosed silo designs may provide increased flexibility for setting up and spotting the equipment at a worksite. Further, the disclosed embodiments may allow storage equipment to be redeployed from one site to another without encountering any difficulties in determining the exact mix of right-hand units and left-hand units desired at the new location. Still further, the disclosed systems and method may simplify the planning, ordering, manufacturing, and deployment process for such dry material storage containers. That is, an operator does not necessarily have to know and/or specify the configuration of the disclosed silo containers prior to their deployment. Instead, the operator may just specify the total quantity of storage silos, and these can be reconfigured on site if desired. The same principle may be applied when ordering repair or replacement parts for the silo units (silo assemblies).

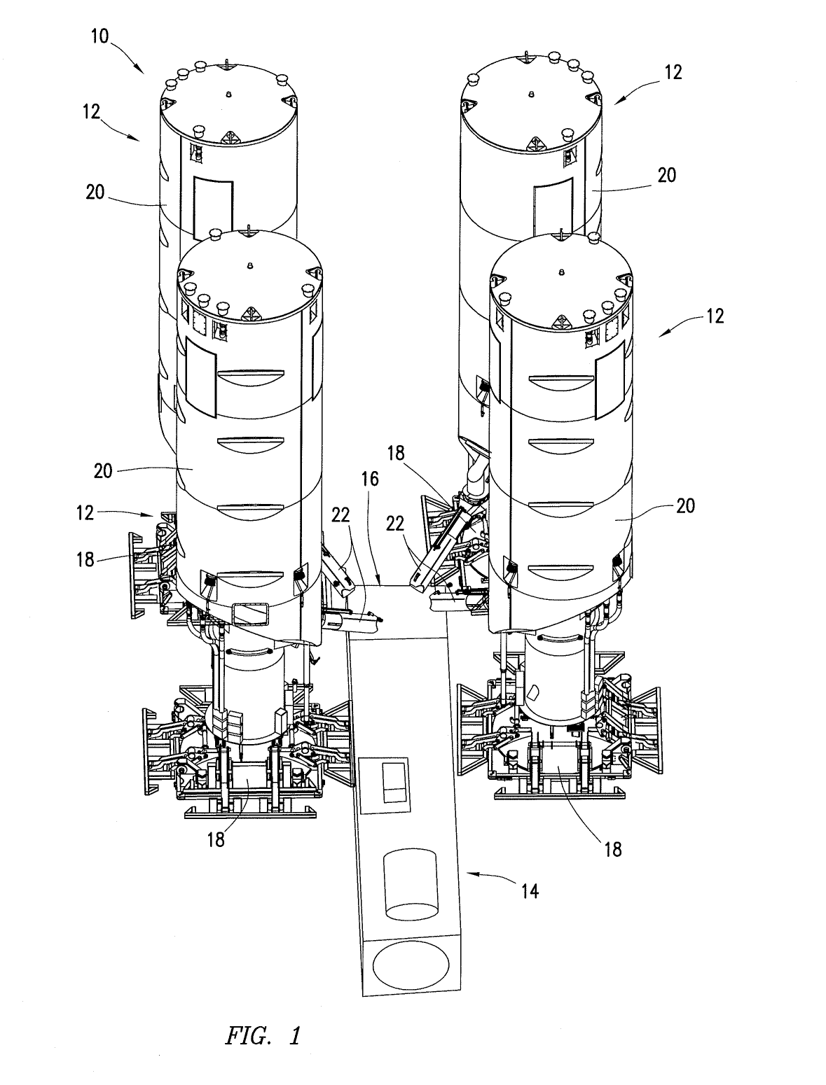

Turning now to the drawings, FIG. 1 is an above perspective view of a system 10 for handling, storing, and transporting a bulk material at a well site. In some embodiments, the bulk material may include a dry material (e.g., proppant, gel particulate, or dry-gel particulate) that can be blended into a fluid for treating a wellbore. The fluid may be pumped into the wellbore during a fracturing treatment in order to create or enhance fractures formed through a downhole formation adjacent the wellbore.

Before the prepared fracturing treatment fluid is provided to the wellbore, the system 10 may facilitate storage, blending, and preparation of the bulk material for use in the treatment fluid. In the illustrated embodiment, the system 10 includes four silo assemblies 12 disposed proximate one another. The silo assemblies 12 are used to store the bulk material before the material is blended into a well treatment fluid. Although not illustrated, a transportation unit may transfer bulk material into one or more of the silo assemblies 12 pneumatically via a flexible hose connection. That is, a transportation unit may utilize pressurized air to carry the bulk material from a portable storage tank of the transportation unit to a desired silo assembly 12.

The system 10 may also include a blender 14, which in the illustrated embodiment is disposed between the silo assemblies 12. The blender 14 may be a truck or skid mounted system that receives bulk material from the silo assemblies 12 and blends the bulk material with water or other fluids and elements to produce the desired well treatment fluid. The blender 14 may include a hopper 16 at one end. The hopper 16 may include a trough designed to receive the bulk material from one or more of the silo assemblies 12.

In presently disclosed embodiments, each silo assembly 12 may include at least a base 18, a storage silo 20, and a discharge chute 22. The base 18 may be used to support the silo 20, and the discharge chute 22 may be coupled to and extend outward from the silo 20 to deliver bulk material from the silo 20 to a downstream component. In present embodiments, the discharge chutes (outlet chutes) 22 may be fixed to the corresponding silos 20. In the following discussion, the term “fixed” with regard to the connection between the chute 22 and the silo 20 does not mean that the chute 22 is rigidly attached to the silo 20. Instead, the term “fixed” should be understood as meaning that one end of the chute 22 is coupled to a fixed location on the silo 20. Portions of the chute 22 may be articulated up and down, or side to side, while the chute 22 remains attached to the fixed location on the silo 20. In the illustrated embodiment, each silo 20 includes just one chute 22. The silos 20 may each be approximately 51 feet tall when vertically oriented as shown, 12 feet across in diameter, and weigh approximately 53,000 pounds.

In the illustrated embodiment, each of the silo assemblies 12 may include discharge chutes 22 extending away from the respective silos 20 and directly into the hopper 16 of the blender truck 14. The blender 14 may be driven and parked between the silo assemblies 12 such that all the discharge chutes 22 extending from the different silos 20 may converge within the hopper 16. Thus, the silo assemblies 12 are able to discharge sand or other bulk material directly into the hopper 16 of the blender 14 using the chutes 22 only and no intermediate points. However, in other embodiments the silo assemblies 12 may be positioned to discharge bulk material to a conveyor or other component located along an intermediate point between the respective silo assembly 12 and the blender 14.

As illustrated, the silo assemblies 12 may be oriented vertically in order to accommodate the converging arrangement of the chutes 22 extending from the silos 20 toward the same hopper 16. As shown, this vertical orientation of the silo assemblies 12 means that each silo assembly 12 is positioned with the longest dimension of its silo 20 oriented substantially parallel to a direction of gravity. In this vertical orientation, the bases 18 may support the respective silos 20 of the silo assemblies 12 on the ground surface.

The vertically oriented silos 20 may also feature at least partially rounded horizontal cross sections. For example, the illustrated silos 20 include circular cross sections. These rounded cross sections may help the silo assemblies 12 to handle a relatively higher pressurization inside the silos 20 as compared to silos that have a prismatic cross section. This slight pressurization within the silo assemblies 12 may enable dust controlling equipment on the silo assembly 12 to operate effectively.

It should be noted that the silos 20 may feature different cross-sectional shapes in other embodiments. For example, the silos 20 may include semi-circular, rectangular, square, or any other desirable shape of horizontal cross section. In the illustrated embodiment, the silo 20 of each silo assembly 12 is shaped with a substantially circular horizontal cross section, while the base 18 of each silo assembly 12 is shaped with a substantially rectangular cross section. In other embodiments, the bases 18 may be formed in other desirable shapes (e.g., rounded). The horizontal cross section of the base 18 may be the same or different from the horizontal cross section of the silo 20 supported by the base 18.

As described in detail below, the disclosed silo assemblies 12 may include silos 20 that are removable and rotatable with respect to their respective bases 18. This may enable relatively simple reconfiguration of the silo assemblies 12 between a first orientation of the outlet chute 22 and a second orientation of the outlet chute 22. Other embodiments of the silo assembly 12 may be designed with multiple attachment points for a transportation system used to transport, position, and erect the vertical silo assembly 12. These reconfigurable silo assemblies 12 may make it relative easy to position a number of large silo assemblies 12 in close proximity to one another at a wellsite, as illustrated.

It should be noted that other types of bulk material handling systems may utilize the techniques disclosed herein. That is, the bulk material handling system shown in FIG. 1 should not be seen as limited to the field of bulk material handling for wellbore applications. The disclosed techniques may be used for any free-flowing granular materials that are transported through a vertical silo.

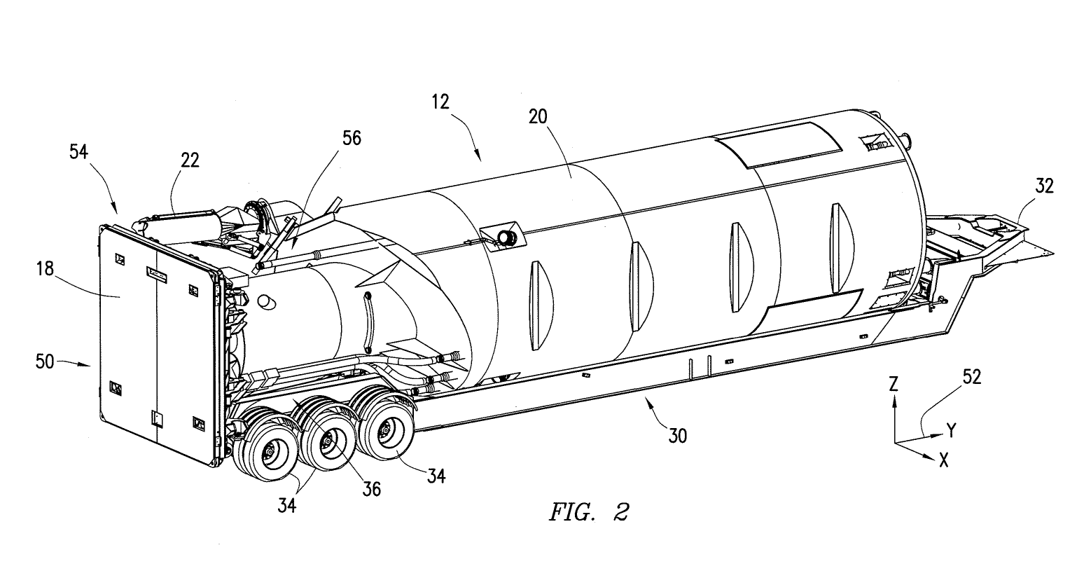

Although the illustrated silos 20 are disposed in a vertical orientation resting on their corresponding bases 18, the silo assemblies 12 may each be transported to/from the worksite in a horizontal orientation on a transportation chassis 30 (e.g., trailer), as shown in FIG. 2. In the illustrated embodiment, the transportation chassis 30 may include a trailer designed to be pulled by a truck (not shown) connected at one end 32 of the trailer. The opposite end of the transportation chassis 30 may include one or more sets of wheels 34 for supporting the transportation chassis 30 and the silo assembly 12 being carried thereon. In the illustrated embodiment, the base 18 of the silo assembly 12 may be positioned at this far end of the transportation chassis 30, opposite the connection end 32. Also at this end, the transportation chassis 30 may include a lifting arm 36 used to erect the silo assembly 12 from the horizontal position on the transportation chassis 30 to the vertical position supported on the ground proximate the transportation chassis 30.

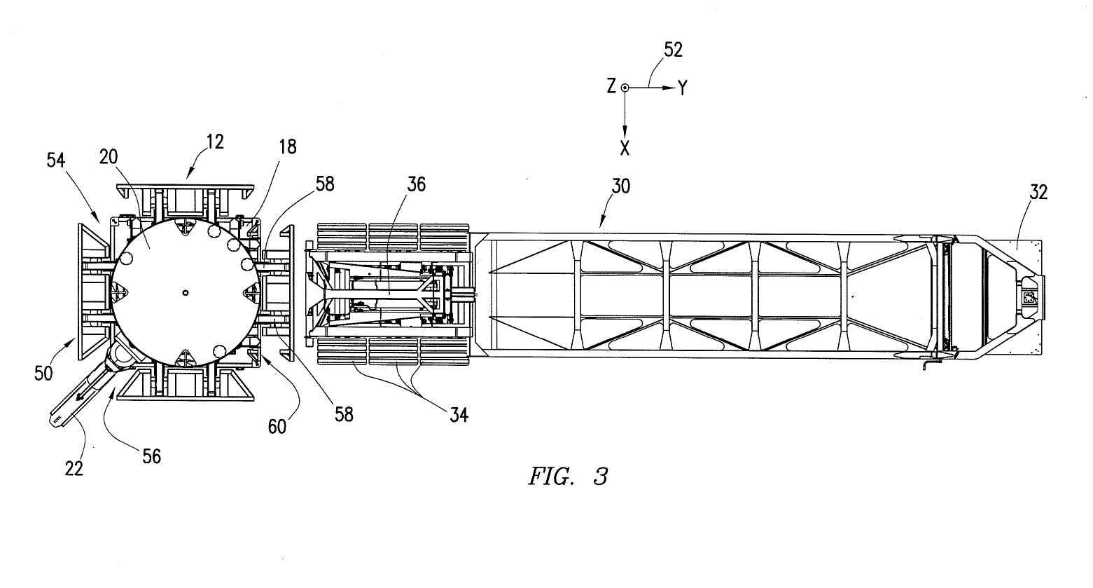

FIG. 3 illustrates the transportation chassis 30 positioned next to a fully erected silo assembly 12. The transportation chassis 30 may be positioned in this manner right after erecting the silo assembly 12 into the vertical orientation, or right before engaging and lowering the silo assembly 12 to a horizontal orientation on the transportation chassis 30.

In FIG. 3, the vertically positioned silo assembly 12 is configured with its chute 22 in a right-hand (first) orientation with respect to the transportation chassis 30. In FIG. 2, the horizontally positioned silo assembly 12 is configured with its chute 22 in a left-hand (second) orientation with respect to the transportation chassis 30. The terms “right-hand orientation” and “left-hand orientation” may refer to the relative position of the chute 22 compared to the side of the base 18 which the transportation chassis 30 abuts. More specifically, when viewed from the back 50 of the transportation chassis 30 (i.e., from the negative direction along y-axis 52) in FIG. 2, the chute 22 appears to be oriented at an upper left-hand corner 54 of the base 18. Likewise, if the silo assembly 12 of FIG. 3 were lowered onto the transportation chassis 30 in a horizontal position (similar to FIG. 2), the chute 22 would appear to be oriented at an upper right-hand corner 56 of the base 18.

The terms “right-hand orientation” and “left-hand orientation” may correspond to different positions in other embodiments. For example, while the illustrated embodiments each include a chute 22 that is fixed to (i.e., coupled to a fixed location on) the corresponding silo 20 at corner positions relative to the rectangular base 18, other embodiments of the silo assembly 12 may include chutes 22 that are disposed along a face of the base 18, instead of at a corner. In such embodiments, the right-hand and left-hand orientations may refer to aligning the chute 22 with certain sides of the base 18 relative to the side abutting the transportation chassis 30. For example, the right-hand orientation may refer to the chute 22 being oriented on the right side of the base 18 when viewed in the horizontal position from the back 50 of the transportation chassis 30. Similarly, the left-hand orientation may refer to the chute being oriented on the left side of the base 18 when viewed in the horizontal position from the back 50.

In still other embodiments, the left and right-hand orientations may refer to aligning the chute 22 with either of two sides of the base 18 that are 90 degrees offset from one another. It should be noted that the left and right-hand orientations may be any desirable number of degrees offset from one another. In addition, more than two specific orientations for the chute relative to the transportation chassis 30 may be employed in some embodiments.

As shown in FIG. 3, the transportation chassis 30 may include the lifting arm 36, which is used to manipulate the silo assembly 12 between a horizontal orientation on the transportation chassis 30 and a vertical orientation with the base 18 on the ground beside the transportation chassis 30. The lifting arm 36 may include attachment features for engaging the silo assembly 12. The lifting arm 36 may also include one or more hydraulic pistons for delivering force to smoothly lift the silo assembly 12 from the horizontal orientation on the transportation chassis 30.

In some embodiments, the lifting arm 36 may be integral with the transportation chassis 30, while in other embodiments the lifting arm 36 may be detachable from the transportation chassis 30. If a detachable lifting arm 36 is used to erect the silo assembly 12 from the transportation chassis 30 to the vertical position on the ground, the lifting arm 36 may then be detached from the transportation chassis 30 and used elsewhere to transport and/or erect other equipment at the worksite.

The lifting arm 36 may be removably coupled to both the base 18 and the silo 20 of the silo assembly 12 during lifting and/or lowering of the silo assembly 12 relative to the transportation chassis 30. In the illustrated embodiment, for example, the base 18 includes lower attachment features 58 for coupling the base 18 to corresponding attachment features of the lifting arm 36. The silo 20 may include one or more upper attachments (not shown) for coupling the silo 20 to the lifting arm 36 as well.

As illustrated, some embodiments of the base 18 may feature a single set of lower attachments 58 on the base 18. With this arrangement, the silo 20 may be rotatable relative to the base 18 for transitioning the chute 22 between a first orientation and a second orientation with respect to the lower attachment 58. The lower attachments 58 may be entirely disposed on a single side 60 of the base 18. In this manner, the base 18 may be attachable in only one orientation relative to the transportation chassis 30. Indeed, this side 60 of the base 18 may be repeatedly engaged/disengaged via the lifting arm 36 during raising and lowering of the silo assembly 12.

As described below, some embodiments of the silo 20 may include multiple upper attachments on different sides of the silo 20, to enable engagement of the lifting arm 36 with the silo 20 after reconfiguring the orientation of the silo 20 with respect to the base 18. In some embodiments, the base 18 may include additional lower attachments 58 on different sides of the base 18 as well.

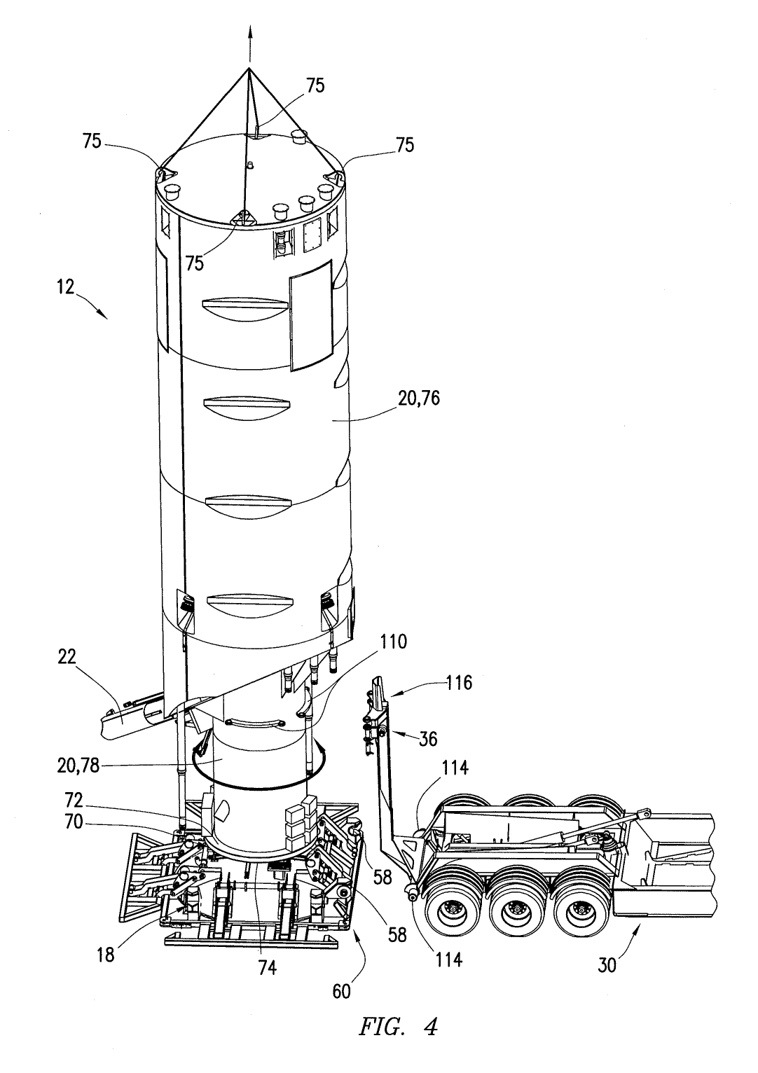

One embodiment of the silo assembly 12 and its attachments for removably coupling the silo assembly 12 with the lifting arm 36 are illustrated in FIG. 4. In this embodiment, the silo 20 is designed to be removably attached to its base 18 in a manner such that the outlet chute 22 from the silo 20 can be positioned in one of two orientations relative to the mounting hardware that connects the silo 20 and the base 18 to the transportation chassis 30. The silo 20 may be removably attached to the base 18 via a mating interface 70 between a flange 72 disposed at a lower end of the silo 20 and a corresponding flange 74 disposed on an upper surface of the base 18. The silo 20 may include hoisting support structures 75 built in to enable a crane to lift and support the silo 20 off the base 18 during reconfiguration of the silo assembly 12 from a first orientation of the chute 22 to a second orientation.

In the illustrated embodiment, the silo 20 includes a tank portion 76 for storing the dry material disposed therein. The tank portion 76 may slope downward at the bottom in order to funnel the dry material down the fixed chute 22. The illustrated silo 20 also includes a stem portion 78 positioned below the tank portion 76. The stern portion 78 may be designed to support the tank portion 76 and to removably couple the silo 20 to the base 18 and/or to the lifting arm 36. Other shapes and arrangements of features that make up the silo 20 may be utilized in other embodiments.

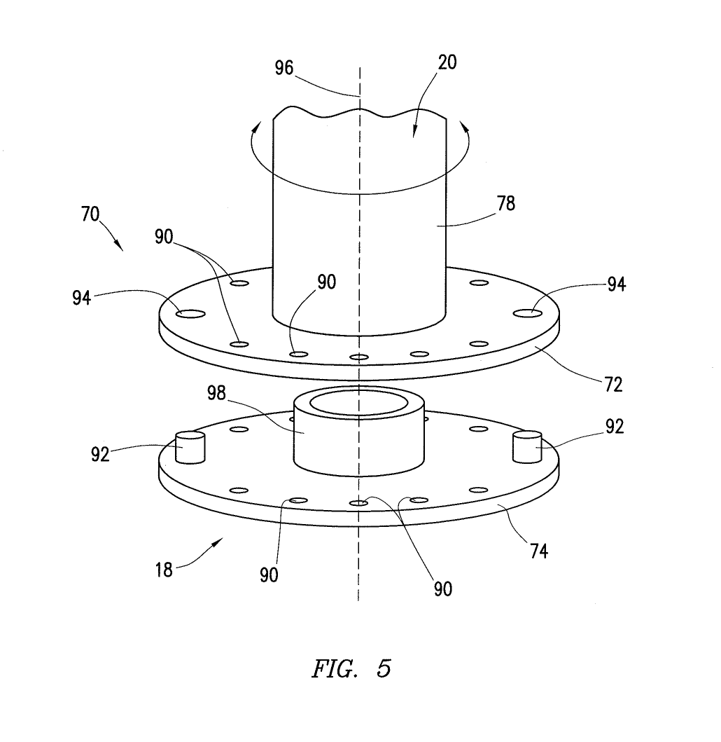

The mating interface 70 may be designed to easily align the silo 20 with respect to the base 18 in either of the two orientations through the use of guide pins and tubes. FIG. 5 illustrates a more detailed view of the mating interface 70 formed between the flange 72 on the silo 20 and the flange 74 on the base 18. The flange 74 may be welded to the base 18, and the flange 72 may be similarly connected to the stem portion 78 of the silo 20.

As illustrated, each of the flanges 72 and 74 that make up the mating interface 70 may feature bolt passages 90 arranged radially along the flanges 72 and 74 and extending longitudinally through the flanges 72 and 74. These bolt passages 90 may be positioned such that they may be brought into alignment between the two flanges 72 and 74. Bolts may be positioned through the aligned bolt passages 90 to secure the flanges 72 and 74 together, thereby removably coupling the silo 20 to the base 18. It should be noted that clamps or other mechanisms for temporarily securing the flange 72 of the silo 20 to the flange 74 of the base 18 may be used in other embodiments.

In some embodiments, the mating interface 70 may include guide pins 92 fanned on one or both of the flanges 72 and 74. The guide pins 92 may be designed to mate with corresponding apertures 94 or other complementary features located on the opposing flanges (e.g., 74 and 72). In the illustrated embodiment, for example, the lower flange 74 includes two guide pins 92 designed to mate with two complementary openings 94 formed in the upper flange 72. These guide pins 92 may help to align the silo 20 with the base 18 in a specific orientation. For example, in the illustrated embodiment the guide pins 92 are substantially similar in shape and size and are disposed 90 degrees from each other about an axis 96 of the silo 20. This may enable the silo 20 to be positioned with respect to the base 18 in one of two orientations that are 90 degrees offset from each other. It should be noted that other embodiments of the mating interface 70 may facilitate repositioning of the silo 20 by other relative angles. For instance, the mating interface 70 may include guide pins 92 positioned to enable repositioning of the silo 20 by 20 degrees, 24 degrees, 30 degrees, 36 degrees, 45 degrees, 60 degrees, 72 degrees, 120 degrees, or 180 degrees, or any other desirable offset orientation.

Other numbers, types, shapes, and combinations of guide pins 92 may be used in other embodiments of the mating interface 70. For instance, certain embodiments may include a pair of guide pins 92 on the upper flange 72 to mate with complementary features (e.g., apertures 94) on the lower flange 74, or the mating interface 70 may include guide pins 92 extending from both flanges 72 and 74. In addition, the guide pins 92 may conform to certain shapes (e.g., round, squared, keyed, etc.). The flanges 72 and 74 may feature guide pins 92 and complementary features 94 disposed about the axis 96 such that they only allow the flanges 72 and 74 to be coupled in a select number of orientations relative to each other. For example, guide pins 92, keyed features, or combinations thereof may be arranged about the flanges 72 and 74 at regular intervals to facilitate a 90 degree rotation of the silo 20 relative to the base 18. This may help to direct the flange 72 into a desired orientation relative to the adjacent flange 74.

In addition to the flanges 72 and 74, the mating interface 70 may include a boss 98 used to keep the two flanges 72 and 74 concentric with each other while the silo 20 is hoisted upward relative to the base 18. In some embodiments, the boss 98 may extend upward into a hollow portion of the stem 78 to maintain the stem 78 and the silo 20 centered over the base 18. The boss 98 may be formed with just a slightly smaller outer diameter than the inner diameter of the hollow stem 78, in order to prevent the stem 78 from shifting an undesirable amount relative to the boss 98 while the silo 20 is being rotated.

Transitioning the chute 22 between a first orientation and a second orientation relative to the base 18 and/or the transportation chassis 30 may be relatively simple using the disclosed silo assembly 12 (e.g., shown in FIG. 4). First, an operator may remove the bolts, clamps, or other attachment features from the mating interface 70. This may effectively disconnect the silo 20 from the base 18. A crane or similar hoisting mechanism may lift the silo 20 away from the base 18. The silo 20 may then be rotated relative to the base (e.g., via the crane, or using additional guide ropes to turn the silo 20). The crane may set the silo 20 back down onto the base 18. Any guide pins present in the mating interface 70 may direct the flange 72 onto the flange 74, thereby aligning the silo 20 in a desired orientation relative to the base 18. An operator may reconnect the silo 20 to the base 18 by inserting bolts, clamps, or other attachment features through the mating interface 70 to secure the flanges 72 and 74 together. In some embodiments, the silo 20 may include quick disconnect features to enable a swift and easy disconnection and reconnection of hydraulic and electronic lines going to or from the silo 20. This may prevent these lines from becoming twisted or damaged during rotation of the silo 20 relative to the base 18.

As mentioned above, the silo assembly 12 may include attachment features for coupling the different parts of the silo assembly 12 to the lifting arm 36 of the transportation chassis 30. FIG. 4 illustrates one embodiment of these attachment features. The base 18 may include the lower attachment 58, and the silo may include one or more upper attachments 110. In the illustrated embodiment, the lower attachment 58 on the side 60 of the base 18 may include a pair of clamps shaped to engage a complementary rod portion 114 of the lifting arm 36. This lower attachment 58 may act as both a connection point between the base 18 and the lifting arm 36 as well as a pivot point between the silo assembly 12 and transportation chassis 30.

The upper attachment 110 may include a latching point extending outward from the circumference of the silo stem 78, and this latching point may trace a portion of the outer circumference. The lifting arm 36 may include a clamp feature 116 designed to engage with the latching point on the silo 20. It should be noted that other types and arrangements of upper and lower attachments 110 and 58, and corresponding attachment points on the lifting arm 36, may be used in other embodiments. The connections formed at the upper attachment 110 and lower attachment 58 may be removable, thereby enabling disengagement of the lifting arm 36 from the silo assembly 12 after it is used to erect the silo assembly 12.

As illustrated, the silo 20 may include two or more upper attachments 110 disposed about the same circumference of the stem 78. One may be used to couple the silo 20 to the lifting arm 36 when the silo 20 is oriented to hold the chute 22 in a left-hand orientation relative to the transportation chassis 30, while the other is used to couple the silo 20 to the lifting arm 36 when the chute 22 is in a right-hand orientation. These upper attachments 110 may be permanent latching points formed on the outer shell of the silo 20.

In other embodiments, the silo 20 may include a single upper attachment 110 formed on the stem 78. This upper attachment 110 may be removable from one position along the circumference of the stem and attachable to a different position along the circumference of the stem 78 to reconfigure the silo 20 for coupling with the lifting arm 36 after the silo 20 has been rotated. In still other embodiments, the single upper attachment 110 may be designed to rotate about the outer shell of the silo 20 for placement in different positions along the circumference of the stem 78. In further embodiments, the upper attachment 110 may include a flange extending all the way around the circumference of the stem 78 to enable coupling of the silo 20 to the lifting arm 36 when the silo 20 is in any orientation relative to the base 18.

In some embodiments, the lower attachment 58 may be reconfigurable as well. For example, although FIG. 4 illustrates the base 18 having the lower attachment 58 on one side 60, in other embodiments the base 18 may be equipped with two sets of lower attachments 58 on different sides of the base 18. This embodiment of the silo assembly 12 may also include a single upper attachment 110 formed on one side of the silo 20. Thus, when the silo 20 is decoupled from and rotated with respect to the base 18, the upper attachment 110 may be rotated out of alignment with one of the lower attachments 58 on the base 18 and into alignment with another lower attachment 58 on the base 18. In other embodiments, the lower attachment 58 may be removable from the side 60 of the base 18 and attachable to another side of the base to facilitate this reconfiguration of the base 18 for attachment to the lifting arm 36.

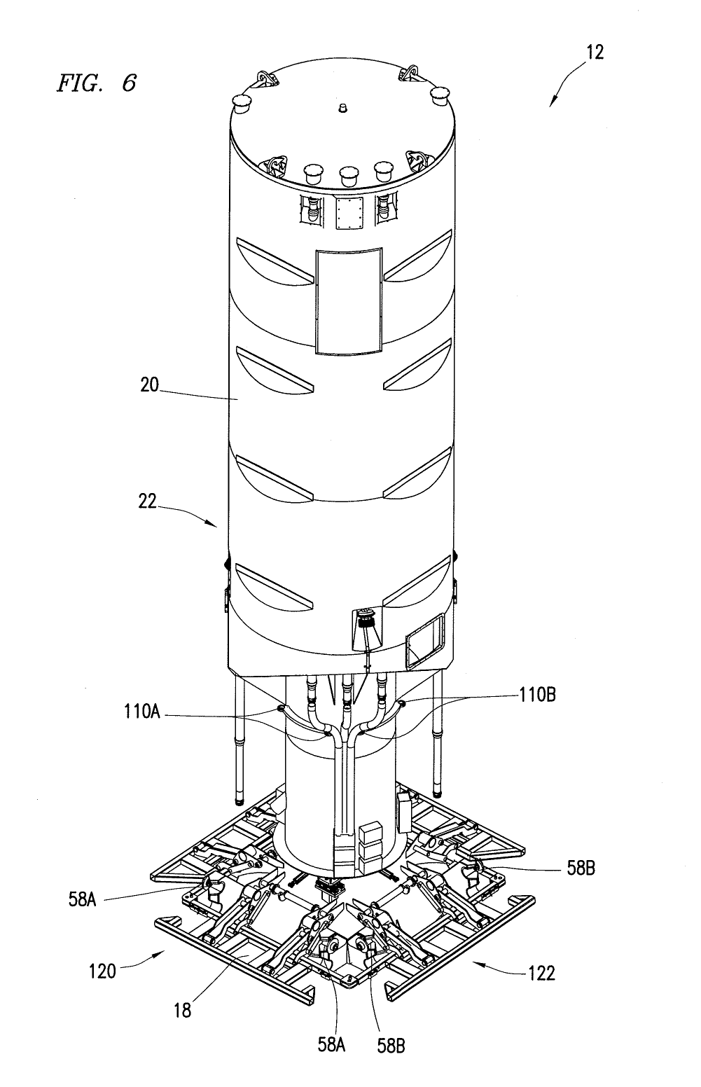

FIG. 6 illustrates another embodiment of the silo assembly 12 that may be used to selectively provide a left-hand orientation and a right-hand orientation of the chute 22 relative to the base 18. In the illustrated embodiment, the chute 22 is disposed on an opposite side of the silo 20 facing into the page. In this embodiment, the silo assembly 12 may include hardware that is configurable to allow connection of the silo 20 to the transportation chassis in two orientations. This hardware may include an upper attachment 110A and a lower attachment 58A disposed on a first side 120 of the silo 20 and the base 18, respectively. In addition, the hardware may include another upper attachment 110B and another lower attachment 58B disposed on a second side 122 of the silo 20 and the base 18, respectively. The hardware (i.e., upper attachment 110A and lower attachment 58A) associated with the first orientation may be disabled or moved to an alternate location when the silo assembly 12 is configured in the second orientation. This may enable configuration of the silo assembly 12 as a right-hand unit (outlet chute 22 located on the upper right-hand corner, looking at the bottom of the base 18 with the silo 20 mounted on the transportation chassis) or as a left-hand unit (outlet chute 22 located on the upper left-hand corner, looking at the bottom of the base 18 with the silo 20 mounted on the transportation chassis).

The disclosed embodiments of the reconfigurable silo assembly 12 described herein may facilitate relatively simple and efficient transportation, erection, and placement of the outlet chute 22 on the silo assembly 12. This simple placement and orientation of the silos 20 may be particularly useful in areas where the available maneuvering space is limited, such as the worksite shown in FIG. 1.

Although the present disclosure and its advantages have been described in detail, it should be understood that various changes, substitutions and alterations can be made herein without departing from the spirit and scope of the disclosure as defined by the following claims.

What is claimed is:

1. A system, comprising:
a storage silo;
a base for supporting the storage silo in a vertical orientation, wherein the storage silo is removably coupled to the base;
a chute coupled to the storage silo at a fixed location on the storage silo; and
a lower attachment disposed on one side of the base for removably coupling the base to a transportation chassis, wherein the storage silo is rotatable relative to the base for transitioning the chute between a first orientation and a second orientation with respect to the lower attachment.

2. The system of claim 1, further comprising a first upper attachment disposed on a first side of the storage silo for removably coupling the storage silo to the transportation chassis.

3. The system of claim 2, wherein the first upper attachment is removable from the first side of the storage silo and removably attachable to a position on a second side of the storage silo offset from the first side.

4. The system of claim 2, further comprising a second upper attachment disposed on a second side of the storage silo offset from the first side.

5. The system of claim 1, wherein the base is attachable in only one orientation relative to the transportation chassis.

6. The system of claim 1, wherein the storage silo is removably coupled to the base via a mating interface between a flange disposed at a lower end of the storage silo and a flange disposed on the base.

7. The system of claim 6, further comprising a plurality of bolts removably positioned through corresponding apertures in the flanges of the storage silo and the base.

8. The system of claim 6, wherein the mating interface comprises one or more guide pins or keyed features that are sized to facilitate a 90 degree rotation of the storage silo relative to the base.

9. The system of claim 6, wherein the mating interface comprises a boss extending from one of the storage silo or the base to maintain concentricity of the storage silo relative to the base.

10. The system of claim 1, wherein the lower attachment is reconfigurable from a position on the one side of the base to a position on another side of the base.

11. The system of claim 1, further comprising a plurality of quick disconnect couplings disposed on the storage silo for providing hydraulic or electronic communications to the storage silo.

12. A system, comprising:
a base;
a storage silo removably coupled to the base;
a chute coupled to the storage silo at a fixed location on the storage silo; and
a transportation chassis comprising a lifting arm removably attached to the base and to the storage silo for erecting the base and the storage silo from the horizontal orientation to a vertical orientation;
wherein the storage silo is rotatable relative to the base for transitioning the chute between a first orientation and a second orientation with respect to the transportation chassis.

13. The system of claim 12, wherein the transportation chassis comprises a trailer for transporting the base and the storage silo in a horizontal position.

14. The system of claim 12, wherein the chute is positioned in the first orientation when the chute is in an upper right-hand corner of the transportation chassis viewed from the back when the storage silo is in the horizontal orientation, and in the second orientation when the chute is disposed in an upper left-hand corner of the transportation chassis viewed from the back when the storage silo is in the horizontal orientation.

15. The system of claim 12, wherein the base comprises a lower attachment disposed on one side of the base for removably coupling the base to the lifting arm.

16. The system of claim 12, wherein the storage silo comprises one or more upper attachments for removably coupling the storage silo to the lifting arm.

17. A method, comprising:
erecting a silo assembly comprising a base and a storage silo from a horizontally aligned position on a transportation chassis to a vertically aligned position supported by the base, via a lifting arm of the transportation chassis;
lifting the storage silo relative to the base via a hoisting mechanism;
rotating the storage silo relative to the base to transition a chute disposed in a fixed position in relation to a location on the storage silo between a left-hand orientation and a right-hand orientation with respect to a lower attachment on the base; and
lowering the storage silo onto the base.

18. The method of claim 17, further comprising disconnecting the storage silo from the base prior to lifting the storage silo and reconnecting the storage silo to the base after lowering the storage silo, wherein disconnecting and reconnecting the storage silo comprises positioning or removing guide pins or other fasteners from between mating flanges on the storage silo and the base.

19. The method of claim 17, further comprising guiding the storage silo into alignment with the base with the chute in the right-hand orientation or in the left-hand orientation via guide pins or keyed features between the storage silo and the base.

20. The method of claim 17, further comprising removing an upper attachment from a first side of the storage silo and coupling the upper attachment to a second side of the storage silo, wherein the upper attachment comprises an interface between the storage silo and the lifting arm.
